(19) United States
(12) Patent Application Publication
(10) Pub. No.: US 2012/0174194 A1
(43) Pub. Date: Jul. 5, 2012

(54) ROLE SETTING APPARATUS, AND ROLE SETTING METHOD

(75) Inventor: Ryo Furukawa, Tokyo (JP)

(73) Assignee: NEC CORPORATION, Tokyo (JP)

(21) Appl. No.: 13/395,389

(22) PCT Filed: Sep. 7, 2010
(86) PCT No.: PCT/JP2010/065318

§ 371 Date: Mar. 9, 2012

(30) Foreign Application Priority Data
Sep. 10, 2009 (JP) 2009-209846

(51) Int. Cl. H04L 9/32

(52) U.S. Cl. 726/4

(57) ABSTRACT

A role setting apparatus includes: an ACL classifying section configured to output an access rule category in which at least one permission and a plurality of user IDs are related to each other, wherein the permission is a combination of a resource ID used to identify a resource as an access object and an action defining permission or non-permission of an operation to the resource, and the plurality of user IDs identify a plurality of users that are access subjects; and an ID attribute storage section configured to store the plurality of user IDs and a plurality of attribute elements, which are related to each other; an role definition storage section configured to store the plurality of attribute elements and a plurality of role definition names, which are related to each other. A role mapping section is configured to acquire a common attribute. which is common to the plurality of user IDs, from the plurality of attribute elements stored in the ID attribute storage section based on the plurality of user IDs of the access rule category, acquire a first role definition name from the plurality of role definition names stored in the role definition storage section based on the common attribute, and relate the access rule category and the first role definition name.

### TECHNICAL FIELD

The present invention is related to a role-based access control, and especially, to a role setting apparatus, a role setting method and a role setting program.

### BACKGROUND ART

Organizations such as business enterprises and groups must carry out an access control for the purpose to fully enforce the internal control such that users belonging to one organization can appropriately access to information and a system. The access control can be generally carried out by setting a combination of a user who is an access subject, a resource as an access object, and an action which defines permission or non-permission of an operation of the resource by the user (hereinafter, to be referred to as an access rule).

As one of access control methods, a role-based access control (RBAC) model is disclosed in Non-Patent Literature 1 (by R. S. Sandhu, E. J. Coyne, H. L. Feinstein, C. E. Youman, “Role-Based Access Control Models” (IEEE Computer, IEEE Press, February, 1996, Vol. 29, the second number, pp. 38-47). The RBAC model is used in an access control method in which a role is defined based on organization configuration, a position and so on. One role can be assigned with a plurality of permissions (a combination of a resource and an action) and a plurality of users. In the RBAC model, the access control can be carried out such that all the users assigned to the one role have all the permissions which are related to it. Because the access control can be carried out based on the role of the user, it is easy to carry out the access control so as to fully attain the internal control in the RBAC model. Therefore, the RBAC model attracts attention to an in-house access control method in recent years.

In order to carry out the access control by using the RBAC model, the setting for assigning a role to a user and a permission is necessary. A role setting method is generally carried out by a manager (hereinafter, to be referred to as a security manager) who manages the access setting of the whole organization by referring to a role definition list to assign the user and the permission to each of role definition names. Hereinafter, this method is referred as a top-down style of the role setting method.

As another role setting method, a role mining method is disclosed in Non-Patent Literature 2 (by Alina Ene, and other five, “Fast Exact and Heuristic Methods for the role Minimization Problems”, (SACMAT '08, ACM Press, June, 2008, pp. 1-10). This role mining method contains the following steps. First, an access control list (ACL) is received on which a plurality of access rules already set to a server on operation are described. Next, all the access rules contained in the ACL are classified into access rule sets each showing a direct product set of a combination of the user set and a permission set. It should be noted that at this time, classification is carried out such that the number of the access rule sets is decreased. Then, access rule categories are generated from the classified access rule sets to represent as a combination of the user set and the permission set and the access rule category is handled as a role. Hereinafter, this method is referred to as a bottom-up style in the role setting method.

### CITATION LIST

[Non-Patent Literature 1]: R. S. Sandhu, E. J. Coyne, H. L. Feinstein, C. E. Youman, “Role-Based Access Control Models” (IEEE Computer, IEEE Press, February, 1996, Vol. 29, 2^{nd}, pp. 38-47)

[Non-Patent Literature 2]: Alina Ene, and other five, “Fast Exact and Heuristic Methods for the role Minimization Problems” (SACMAT '08, ACM Press, June, 2008, pp. 1-10)

### SUMMARY OF THE INVENTION

In the method of the top-down style of role setting, the system is built in consideration of the environment that the whole organization can access to information in proper state. Therefore, the security manager needs to grasp the job content of each of employees over the whole organization and to set a role from the job contents. However, this is a large load to the security manager. Therefore, in the actual role setting method, the security manager sets a role in a range to be understandable. The access rule which can not be set by the RBAC model is set an access rule in units of individuals exceptionally. In the role setting method in the top-down style, because the role is set based on a role definition book, the role which the security manager is easy to understand can be set, but there is a problem that the role is set, departing from the actual condition of the scene.

On the other hand, in the role setting method in the bottom-up style, a role can be set along the actual condition of the scene just as it is without paying for the cost to generate an access rule category based on the ACL. However, the present role setting method in the bottom-up style, the users having the same permission which is described in the ACL is set simply as the users of one access rule category. Therefore, the role definition corresponding to each of the set access rule categories is not evident and the correspondence is difficult. Therefore, the role setting method in the bottom-up style is difficult in the management of the roles and has a problem in case of internal control.

In this way, the role setting method in the top-down style and the role setting method in the bottom-up style have merits and demerits respectively and a method having both merits is requested.

The present invention provides a role setting apparatus which has merits of both of the role setting method in the top-down style and the role setting method in the bottom-up style, and which can easily relate a role which the security manager is easy to understand and an access rule category which reflects the actual condition of the scene.

The role setting apparatus of the present invention is provided with an ACL classifying section configured to output an access rule category in which at least one permission and a plurality of user IDs used to identify a plurality of users as access subjects are related to each other, wherein the at least one permission is a combination of a resource ID used to identify a resource as an access object and an action defining permission or non-permission of an operation to the resource; an ID attribute storage section configured to store the plurality of user IDs and a plurality of attribute elements, which are related to each other; an role definition storage section configured to store the plurality of attribute elements and a plurality of role definition names, which are related to each other; and a role mapping section configured to acquire a common attribute which is common to the plurality of user IDs, from the plurality of attribute elements stored in the ID attribute storage section based on the plurality of user IDs of the access rule category, acquire a first role definition name from the plurality of role definition names stored in the role definition storage section based on the common attribute, and relate the access rule category and the first role definition name.

The role setting method of the present invention is provided with the steps of: outputting an access rule category in which at least one permission and a plurality of user IDs used to identify a plurality of users as access subjects are related to each other, wherein the at least one permission is a combination of a resource ID used to identify a resource as an access object and an action defining permission or non-permission of an operation to the resource; acquiring a common attribute which is common to the plurality of user IDs from an ID attribute storage section which relates and stores the plurality of user IDs and a plurality of attribute elements, based on the plurality of user IDs of the access rule category; acquiring a first role definition name from a role definition storage section which relates and stores the plurality of attribute elements and a plurality of role definition names, based on the common attribute; and relating the access rule category and the first role definition name.

The role setting program of the present invention make a computer execute the steps of: outputting an access rule category in which at least one permission and a plurality of user IDs used to identify a plurality of users as access subjects are related to each other, wherein the at least one permission is a combination of a resource ID used to identify a resource as an access object and an action defining permission or non-permission of an operation to the resource; acquiring a common attribute which is common to the plurality of user IDs from an ID attribute storage section which relates and stores the plurality of user IDs and a plurality of attribute elements, based on the plurality of user IDs of the access rule category; acquiring a first role definition name from a role definition storage section which relates and stores the plurality of attribute elements and a plurality of role definition names, based on the common attribute; and relating the access rule category and the first role definition name.

The role setting apparatus of the present invention can easily relate a role which a security manager is easy to understand and an access rule category which reflects an actual condition of scene.

### BRIEF DESCRIPTION OF THE DRAWINGS

The purpose, effect, characteristic of the present invention would be clearer from description of the exemplary embodiments in conjunction with the attached drawings:

FIG. 1 is a block diagram showing a configuration example of a role setting apparatus 100 of the present invention;

FIG. 2 is a diagram showing an example of ACL stored in an ACL storage section 110;

FIG. 3 is a diagram showing an example of a set of access rule categories generated based on the ACL;

FIG. 4 is a diagram showing an example of user IDs and ID attributes, which are stored in an ID attribute storage section 130;

FIG. 5 is a diagram showing an example of a role definition name and a role definition attribute, which are stored in a role definition storage section 140;

FIG. 6 is a diagram showing an example of an access rule in which the access rule category, and the role definition name are related with each other and which is stored in a role data storage section 160;

FIG. 7 is a block diagram showing a hardware configuration example of the role setting apparatus 100 according to an exemplary embodiment of the present invention;

FIG. 8 is a flow chart showing a processing operation of the role setting apparatus 100 according to the exemplary embodiment of the present invention;

FIG. 9 is a flow chart showing a processing operation when the role mapping section 150 determines a role definition name which is related to the access rule category;

FIG. 10 is a block diagram showing a configuration example of the role setting apparatus 100 in an example of the present invention;

FIG. 11 is a flow chart showing a processing operation when an ACL classifying section 120 generates the access rule category set;

FIG. 12 is a diagram when the ACL classifying section 120 relates a user ID and a permission set based on the ACL in FIG. 2.

### DESCRIPTION OF EXEMPLARY EMBODIMENTS

Hereinafter, a role setting apparatus, a role setting method, and a role setting program according to exemplary embodiments of the present invention will be described with reference to the attached drawings.

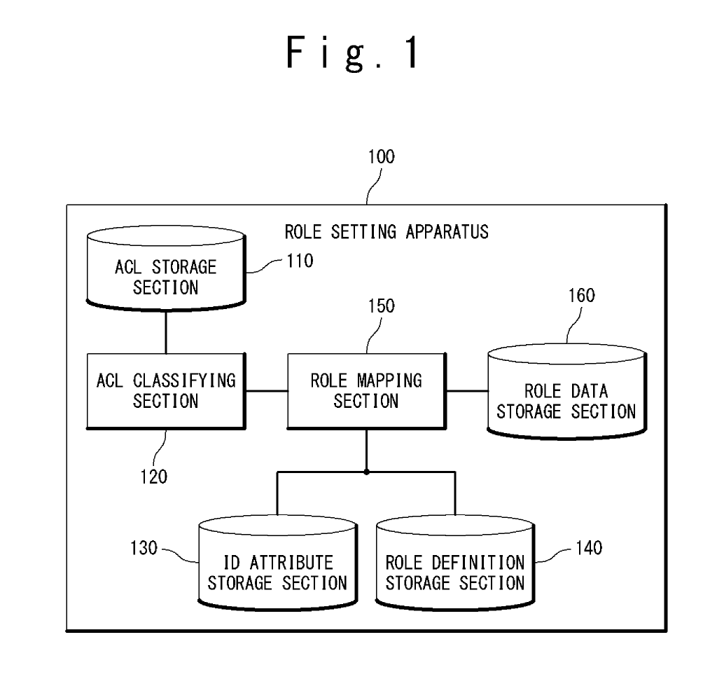

FIG. 1 is a block diagram showing a configuration example of the role setting apparatus 100 of the present invention. Referring to FIG. 1, the role setting apparatus 100 is provided with an access control list (ACL) storage section 110, an ACL classifying section 120, an ID attribute storage section 130, a role definition storage section 140, a role mapping section 150 and a role data storage section 160.

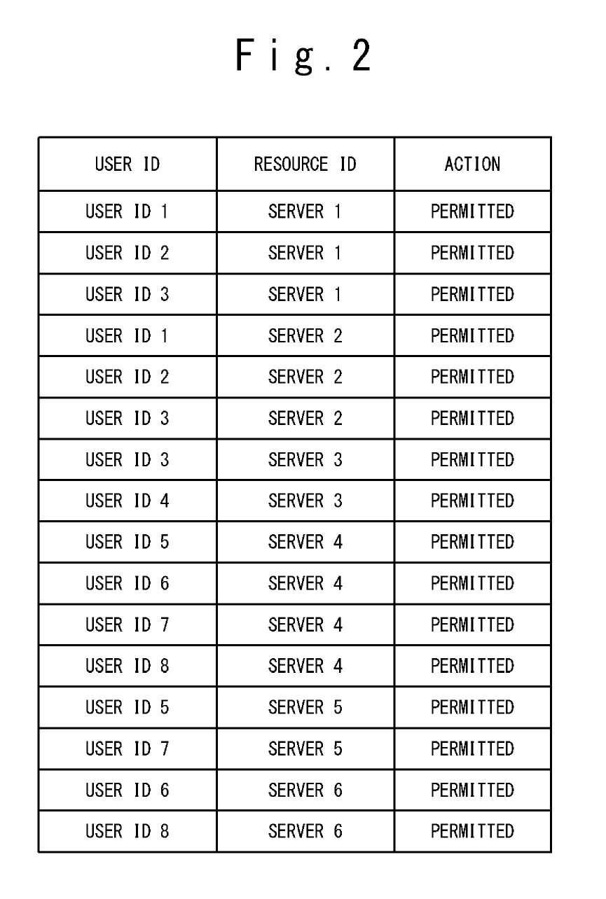

The ACL storage section 110 stores an ACL in which a set of a plurality of access rules is described. The access rule is described as a combination of a user ID used to identify a user such as a name and a number of the user, a resource ID used to identify a resource such as a name and a number of the resource, and an action which prescribes permission or non-permission of an operation to the resource by the user. FIG. 2 is an example of the ACL stored in the ACL storage section 110. Referring to FIG. 2, the ACL has the fields of the user ID, the resource ID and the action. For example, one access rule is shown as a combination of user 1, server 1 and permission of action.

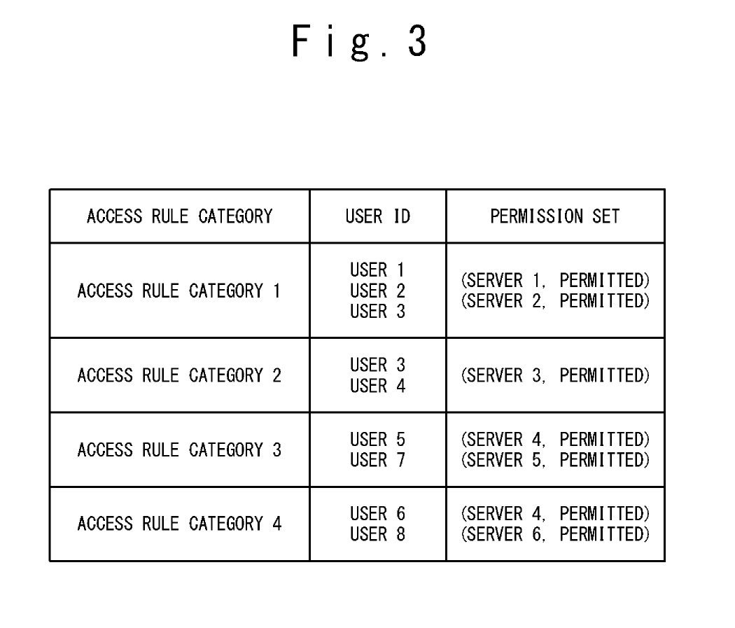

The ACL is acquired from the ACL storage section 110 by the ACL classifying section 120. The ACL classifying section 120 classifies access rules (a plurality of access rules) described in the acquired ACL into a direct product set of a group of user IDs (a plurality of user IDs) and a group of permissions (at least one permission), and generates access rule categories (a plurality of access rule categories). The ACL classifying section 120 classifies the access rules to decrease the number of access rule categories when generating the access rule categories. The ACL classifying section 120 outputs the generated access rule categories to the role mapping section 150. FIG. 3 is a diagram showing an example of the access rule categories generated based on the ACL. Referring to FIG. 3, the group of user IDs (a plurality of user IDs) and a permission set (at least one permission) are related to one access rule category. In other words, the ACL classifying section 120 outputs one access rule category in which at least one permission as a set of a resource ID used to identify a resource of an access object and an action for prescribing the permission or non-permission of the operation of the resource and a plurality of user IDs which identify a plurality of users who are access subjects are related with each other. The details when the ACL classifying section 120 generates the access rule categories from the access rules will be described later.

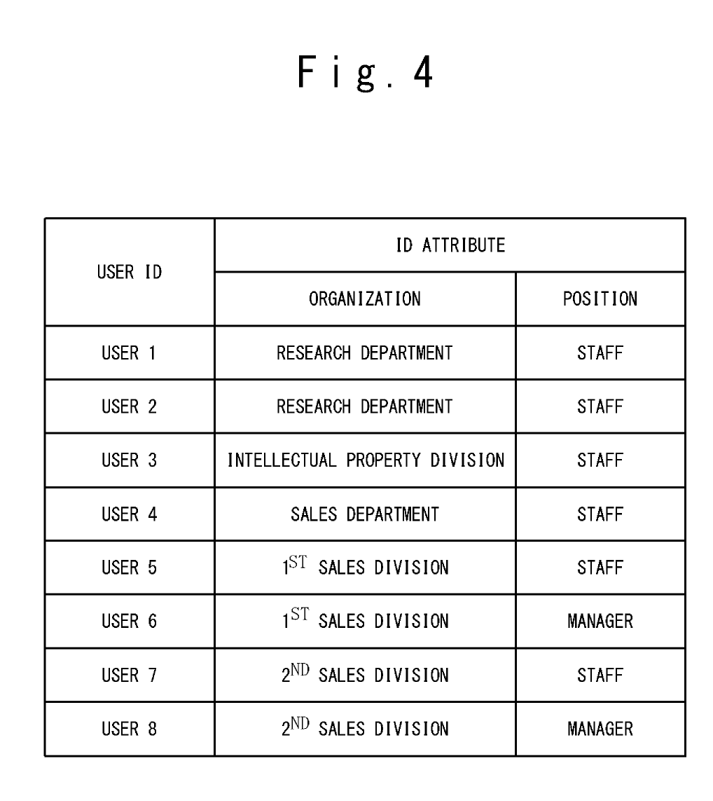

The ID attribute storage section 130 relates and stores all the user IDs and ID attributes, respectively. The ID attributes contain a plurality of attribute types, and each attribute type is shown by one or more attribute elements which are selected from one or more attribute sets. FIG. 4 is a diagram showing an example of the user IDs and the ID attributes which are stored in the ID attribute storage section 130. Referring to FIG. 4, the ID attribute has two attribute types of “organizations” and “position”. The attribute type of “organization” is represented by at least one attribute element selected from an attribute set of two attribute elements of “department” and “division”. In this way, the ID attribute storage section 130 relates and stores user IDs and ID attributes, i.e. attribute elements.

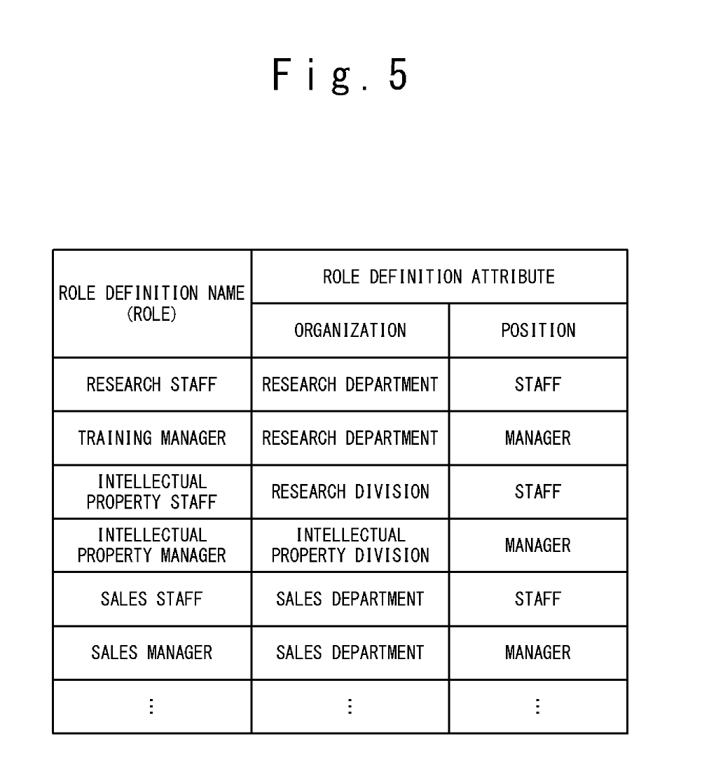

The role definition storage section 140 relates and stores a plurality of role definition names defined in a top-down style and role definition attributes which feature of the plurality of role definition names. The role definition attribute contains a plurality of attribute types, and each attribute type is represented by one or more attribute elements selected from a set of attribute elements. FIG. 5 is a diagram showing an example of the role definition names and the role definition attributes stored in the role definition storage section 140. Referring to FIG. 5, the role definition attribute has two attribute types of “organizations” and “position”. The attribute type of “organization” is represented by one or more attribute elements selected from the attribute set of two attribute elements of “department” and “division”. In this way, the role definition storage section 140 relates and stores the role definition names and the role definition attributes, i.e. a plurality of attribute elements. It should be noted that all attribute types are common between the role definition attributes stored in the role definition storage section 140 and the ID attributes stored in the ID attribute storage section 130. Moreover, each attribute element which is set to the attribute type which is common between the ID attribute and the role definition attribute is selected from the same attribute set.

The role mapping section 150 receives the access rule categories from the ACL classifying section 120. The role mapping section 150 uses the ID attribute storage section 130 and the role definition storage section 140 and determines a role definition name to be related to an access rule category. In detail, the role mapping section 150 acquires the entire user IDs contained in one access rule category. The role mapping section 150 calculates a common ID attribute which is common to the acquired user IDs from the ID attribute (attribute elements) stored in the ID attribute storage section 130. Then, the role mapping section 150 acquires the role definition name from the plurality of role definition names stored in the role definition storage section 140 based on the common ID attribute and relates it to the access rule category. The role mapping section 150 maps the access rule category and the acquired role definition name and outputs them to the role data storage section 160.

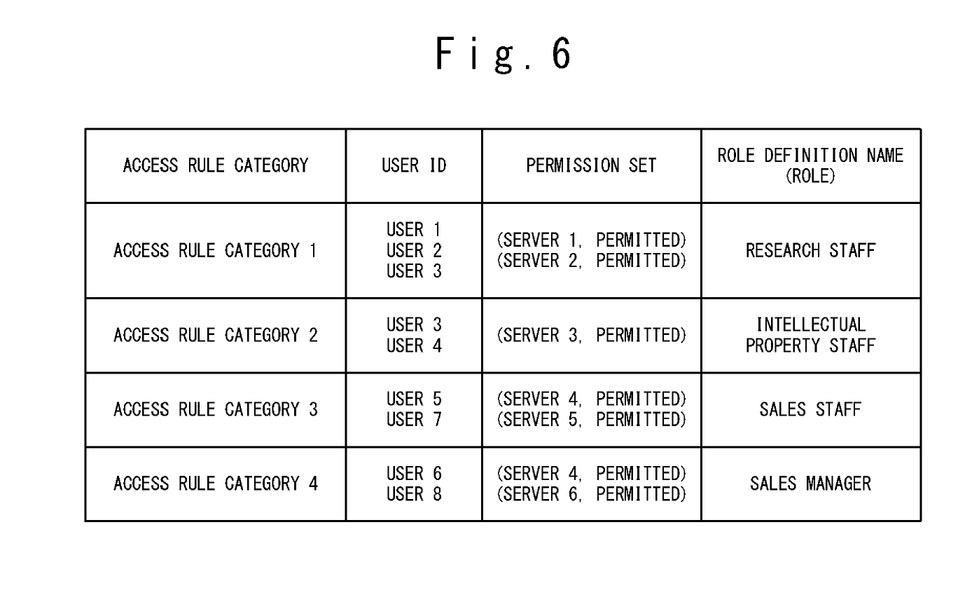

The role data storage section 160 stores an access rule in which the access rule category and the role definition name are related to each other and which is received from the role mapping section 150. FIG. 6 is a diagram showing an example of the access rule in which the access rule category and the role definition name are related to each other and which is stored in the role data storage section 160.

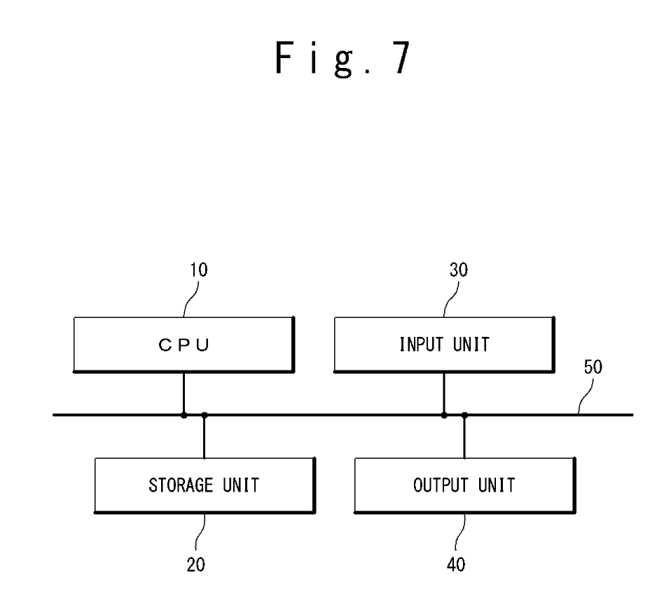

The role setting apparatus 100 according to the exemplary embodiment of the present invention can be realized by using a computer. FIG. 7 is a block diagram showing a hardware configuration example of the role setting apparatus 100 according to the exemplary embodiment of the present invention. Referring to FIG. 7, the role setting apparatus 100 of the present invention is configured of a computer system which is provided with a CPU (Central Processing Unit) 10, a storage unit 20, an input unit 30, an output unit 40 and a bus 50 which connects these units.

The CPU 10 carries out calculation processing and control processing of the role setting apparatus 100 of the present invention based on a computer program installed in the storage unit 20. The storage unit 20 is a unit for storing data such as a hard disk and a memory. The storage unit 20 stores a computer program read from a computer-readable storage medium such as a CD-ROM and a DVD, a signal and program supplied from input unit 30, and a processing result of the CPU 10. The input unit 20 is a unit for inputting the signal and commands by a security manager, such as a mouse, a keyboard, and microphone. The output unit 40 is a unit for supplying an output result to the security manager, such as a display and a speaker. It should be noted that the present invention is not limited to the hardware configuration example and each section can be realized independently or in a combination in a hardware scheme and a software scheme.

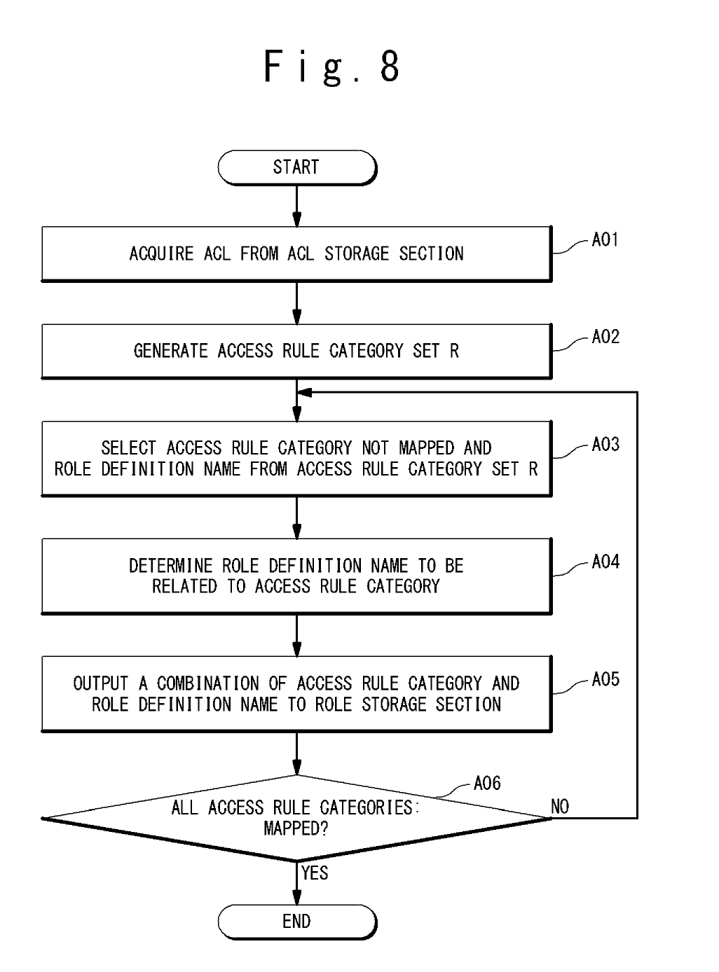

FIG. 8 is a flow hart showing a processing operation of the role setting apparatus 100 according to the exemplary embodiment of the present invention. Referring to FIG. 8, the processing operation according to the exemplary embodiment of the present invention will be described.

The ACL classifying section 120 acquires the ACL from the ACL storage section 110 (Step A01).

The ACL classifying section 120 generates access rule category set R using the acquired ACL (Step A02). In detail, the ACL classifying section 120 classifies the access rule sets which are described in the acquired ACL into direct product sets of a user ID set and a permission set, and generates an access rule category set R. At this time, the ACL classifying section 120 carries out the classification such that the number of access rule categories contained in the access rule category set R is reduced. It should be noted that if the access rule categories are outputted from the access rule sets, whatever method may be used for the ACL classifying section 120. For example, the role mining method described in Non-Patent Literature 2 can be used for the ACL classifying section 120.

The role mapping section 150 selects the role definition name and the access rule category which is not mapped, from among the access rule category set R received from the ACL classifying section 120 (Step A03).

The role mapping section 150 uses the ID attribute storage section 130 and the role definition storage section 140 to determine the role definition name to be related to the access rule category (Step A04).

The role mapping section 150 carries out mapping of the access rule category and the role definition name and outputs a combination of the access rule category and the role definition name to the role data storage section 160 (Step A05).

The role mapping section 150 determines whether or not all the access rule categories contained in the acquired access rule category set R are mapped with the role definition name (Step A06).

If the mapping is not completed at the step A06, the control flow returns to the step A03 which selects the access rule category which is not selected. If the mapping is completed at the step A06, the role mapping section 150 ends the processing.

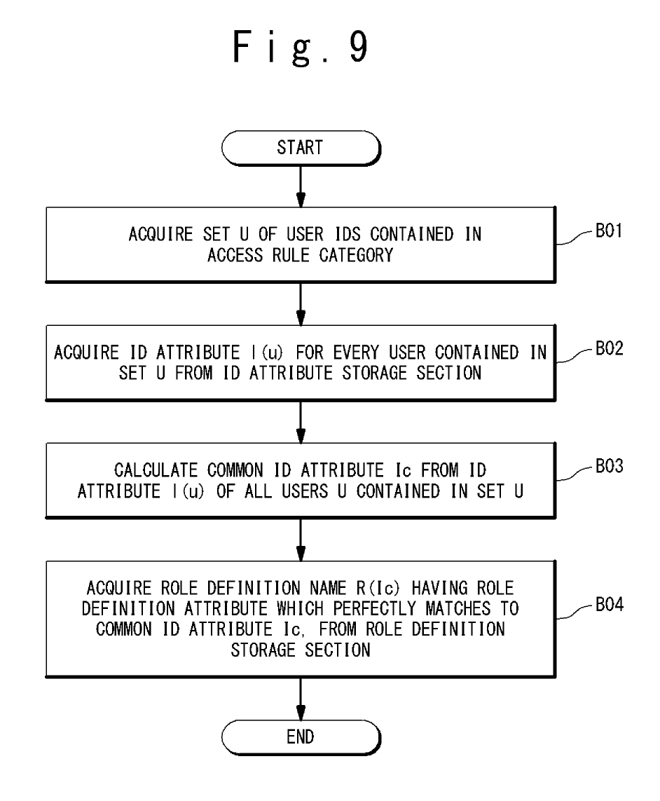

FIG. 9 is a flow chart showing a processing operation of determining the role definition name which is related to the access rule category. Referring to FIG. 9, the processing operation of the role mapping section 150 at the step A04 of FIG. 8 will be described.

The role mapping section 150 acquires a user ID set U contained in the selected access rule category (Step B01).

The role mapping section 150 acquires an ID attribute (a plurality of attribute elements) I(u) every user u to all the users u contained in the user ID set U (u∈U) from the ID attribute storage section 130 (Step B02).

The role mapping section 150 calculates a common ID attribute Ic which is an ID attribute common to all the user IDs from among the ID attribute I(u) every acquired user ID (from among the ID attribute I(u) of all the users u contained in the user ID set U) (Step B03). The method of calculating the common ID attribute is exemplified as a method of deriving the plurality of attribute elements common to all the users for every attribute type and obtaining a combination of the plurality of common attribute elements (a common attribute set) and the attribute type.

The role mapping section 150 searches the role definition storage section 140 for the role definition name R(Ic) which has the role definition attribute which perfectly matches to the common ID attribute Ic and acquires it (Step B04). In the search processing, the role mapping section 150 searches the role definition name R(Ic) in which a common attribute set of common ID attribute Ic and the plurality of attribute elements of the role definition attribute perfectly match to each other every attribute type. When there is not any role definition name R(Ic), no role definition name R(Ic) is outputted.

As described above, in the role setting apparatus 100 of the present invention, the ACL classifying section 120 outputs the set of access rules defined as the role automatically from the ACL as the set of access rule categories so as not to dissociate from the actual condition of the scene. The role mapping section 150 can map the access rule category which reflects the actual condition of the scene generated in a bottom-up style and the role definition name which can be understood by the security manager such as an organization name and a position which are set in the top-down style. Thus, the role setting apparatus 100 of the present invention can attain advantages in both of the role setting method in the top-down style of and the role setting method in the bottom-up style. That is, the role setting apparatus 100 of the present invention can automatically carry out the role setting to reflect the actual condition of the scene, and for the security manager to be easy to understand. Moreover, the role setting apparatus 100 of the present invention attains the effect which can reduce the cost of the role setting.

The processing operation of the role setting apparatus 100 of the present invention will be described in detail by using a specific example. In this example, a case where the role setting apparatus 100 carries out an access control to an in-house server will be described. The outline of the processing is as follows. The role setting apparatus 100 stores a department and/or division to which a user belongs, as an ID attribute of the user and stores an organization name as a role definition name. The role setting apparatus 100 collects the ACL related to an access control to the in-house server and sets an access rule category. Then, the role setting apparatus 100 maps an access rule category onto the role definition name represented by the organization name.

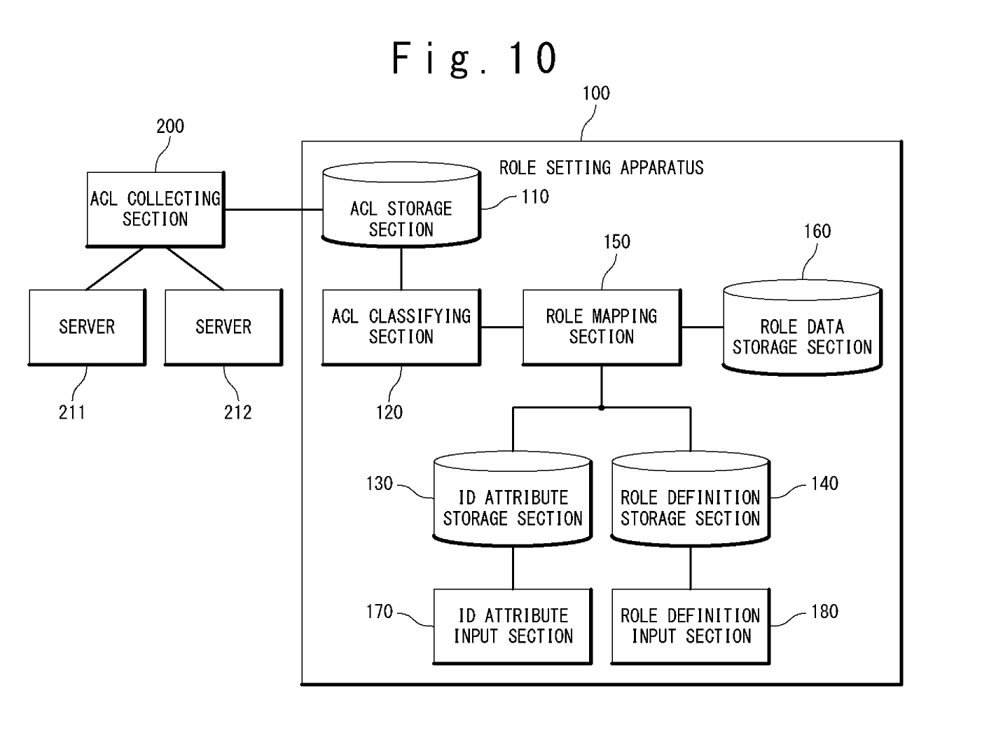

FIG. 10 is a block diagram showing the configuration example of the role setting apparatus 100 in an example of the present invention. Referring to FIG. 10, the role setting apparatus 100 is provided with the ACL storage section 110, the ACL classifying section 120, the ID attribute storage section 130, the role definition storage section 140, the role mapping section 150, the role data storage section 160, the ID attribute input section 170 and the role definition input section 180.

The ID attribute input section 170 outputs a user ID and an ID attribute to the ID attribute storage section 130 based on the input of the security manager to the role setting apparatus 100. The role definition input section 180 outputs a role definition name and a role definition attribute to the role definition storage section 140 based on the input of the security manager.

The ACL collecting section 200 acquires the ACL from each of the plurality of servers (servers 211, 212, . . . , 21N), in which the ACL is set. The ACL storage section 110 is connected with the ACL collecting section 200 and stored the ACL acquired from each of the plurality of servers.

The processing operation of the role setting apparatus 100 shown in FIG. 10, that is, an operation of automatically settings an access rule category and mapping to the role definition name will be described in detail. It should be noted that it will be described based on a flow chart shown in FIG. 8.

The ID attribute input section 170 outputs a user ID and an ID attribute to the ID attribute storage section 130 based on an input of the security manager. The ID attribute storage section 130 relates and stores the user ID and the ID attribute. Referring to FIG. 4, the user ID and the ID attribute stored in the ID attribute section 130 will be described. Referring to FIG. 4, in this example, there are an “organization” and a “position” as an attribute type. An attribute set corresponding to the attribute type of “organization” is a “department” and a “division” to which the user belongs. The plurality of attribute elements (a research department, a sales department, a research division, an intellectual property division, a 1^{st} sales division, and a 2^{nd} sales division) which are selected from the attribute sets of “department” and “division” are set to the attribute type of “organization”. The attribute set corresponding to the attribute type of “position” is a set of the positions, and the attribute elements (a staff and a manager) which are selected from the set are set. FIG. 4 shows that a user 3 concurrently belongs to the “research division” and the “intellectual property division”. It should be noted that a security manager can easily input correspondence relation between the user ID and the ID attribute from personnel information.

The role definition input section 180 outputs a role definition name and a role definition attribute to the role definition storage section 140 based on an input of the security manager. Referring to FIG. 5, the role definition name and the role definition attribute stored in the role definition storage section 140 will be described. The role definition name shows an organization. The role definition attribute has a “position” and an “organization”, which are the same as the ID attribute of the ID attribute storage section 130. The attribute set corresponding to the attribute type of “organization” is a “department” and a “division” to which the user belongs, like the above-mentioned ID attribute. The plurality of attribute elements (a research department, a sales department, a research division, and an intellectual property division) which are selected from the attribute sets of the “department” and the “division” are set to the attribute type of “organization”. Also, the attribute set corresponding to the attribute type of “position” is a set of the positions. The attribute elements (a staff, a manager) which are selected from the set are set. It should be noted that the security manager can easily input a correspondence relation between the role definition name and the role definition attribute from organization information.

Next, the ACL collecting section 200 collects the ACLs which are set to the plurality of servers (servers 271, 272, . . . , 27 N). The ACL collecting section 200 outputs the ACLs to the ACL storage section 110. Referring to FIG. 2, the ACL stored in the ACL storage section 110 in this example will be described. Referring to FIG. 2, the ACL of this example contains a staff name as the user ID, a server name as a resource ID, permission and non-permission of an access as an action.

The ACL classifying section 120 acquires the ACLs from the ACL storage section 110 (step A01 in FIG. 8).

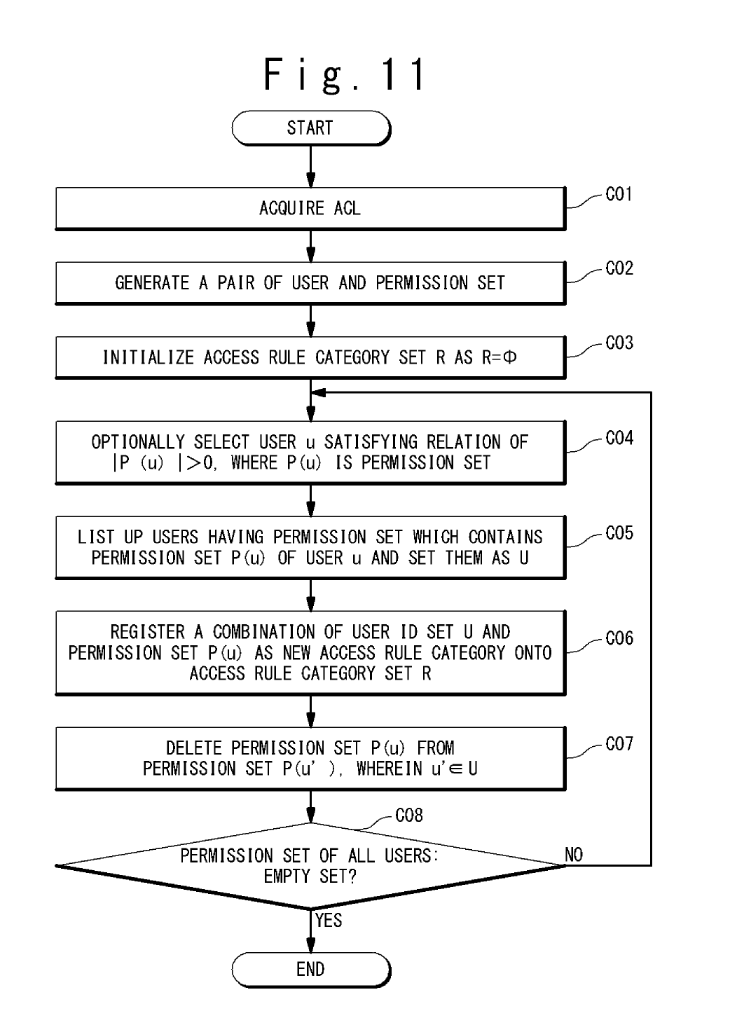

The ACL classifying section 120 generates a set of access rule categories from the ACLs (step A02 in FIG. 8). It is supposed that the ACL classifying section 120 generates the set of access rule categories according to the method of Non-Patent Literature 2 in this example. FIG. 11 is a flow chart showing the processing operation when the ACL classifying section 120 generates the set of access rule categories. Referring to FIG. 11, the processing operation of the ACL classifying section 120 will be described.

The ACL classifying section 120 acquires all the ACL stored in the ACL storage section 110 (Step C01).

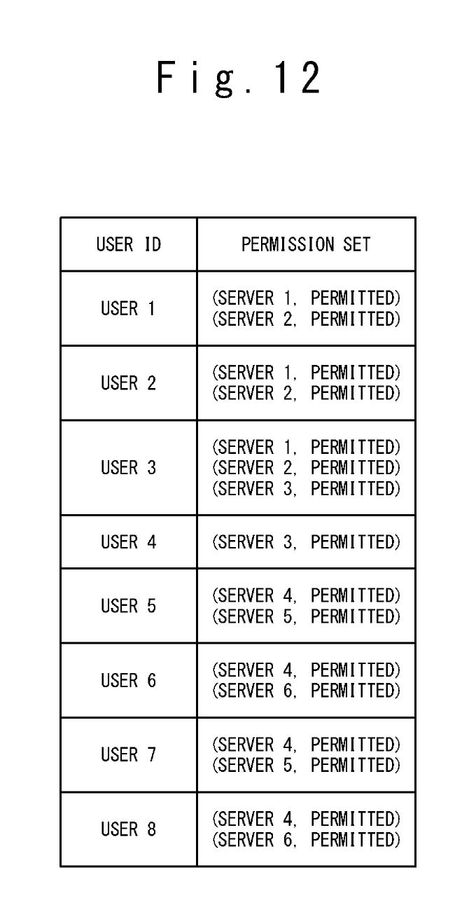

The ACL classifying section 120 extracts an optional user ID from the access rule set (a combination of a user ID set, a resource ID, and an action) which is contained in the ACL, and generates a pair of the user ID and the permission set (the combination of the resource ID and the action). The ACL classifying section 120 generates a pair of the user ID and the permission set to each of the user IDs (Step C02). FIG. 12 is a diagram showing relation of the user ID and the permission set based on the ACL shown in FIG. 2 by the ACL classifying section 120. Referring to FIG. 12, for example, the permission set of a user 1 can be set as {(server 1, permission), (server 2, permission)}.

The ACL classifying section 120 initializes the access rule category set R to an empty set R=Φ (Step C03).

The ACL classifying section 120 optionally selects the user u satisfying |P(u)|>0, where P(u) is the permission set (Step C04). For example, it is possible to select the user 1 of FIG. 12 because the user 1 has {(server 1, permission), (server 2, permission)} as the permission set.

The ACL classifying section 120 lists up the user IDs which have the permission sets which include the permission set P(u) of the user u and sets them as a set U (Step C05). For example, the user 1, the user 2 and the user 3 are listed up for the user ID which has the permission set which includes the permission set {(server 1, permission), (server 2, permission)} of the user 1 as a user u. In other words, the user 2 has the permission set {(server 1, permission), (server 2, permission)} and the user 3 has a permission set {(server 1, permission), (server 2, permission), (server 3, permission)}. The user ID set U becomes a set U={user 1, user 2, user 3}.

The ACL classifying section 120 registers a set of the set U of the listed user IDs and permission set P(u) on access rule category set R as the new access rule category (Step C06). Thus, a combination of the set U of the listed user ID={user 1, user 2, user 3}, and the permission set P(u) of the user 1={(server 1, permission), (server 2, permission)} is registered on the access rule category set R as an access rule category 1. The access rule category set R becomes R={access rule category 1}.

The ACL classifying section 120 removes the permission set P(u) from the permission set of the user u′∈U. Thus, the permission sets (server 2, permission) and (server 1, permission) which are assigned to the access rule category 1 are removed from the permission sets of each of the users 1, the users 2, the users 3 (Step C07). As a result, the permission sets of the user 1 and the user 2 are removed. In the permission set of the user 3, {(server 3, permission)} is left, and the permission sets of the users 5 to 8 are not changed.

When the permission sets of all the users are not empty sets at the step C08, the ACL classifying section 120 carries out the processing at the step C04 to select the user u optionally. When the permission sets of all the users are empty sets at the step C08, the ACL classifying section 120 ends the processing. Here, the control flow returns to the step C04 because the permission sets of the user 3, the user 4, the user 5, the user 6, the user 7, and the user 8 are not the empty set. Lastly, the ACL classifying section 120 outputs the access rule category set R and ends the processing. In this example, the ACL classifying section 120 outputs the access rule category set R registered with four access rule categories, as shown in FIG. 3, and the processing of an ACL classifying section ends.

Next, the role mapping section 150 determines the role definition name to be mapped to each of the access rule categories contained in the access rule category set R. The role mapping section 150 selects the access rule category 1 as the access rule category that the role definition name is not yet mapped (the step A03 in FIG. 8).

The role mapping section 150 acquires the user ID set U={user 1, user 2, user 3} which is contained in the access rule category 1 (the step A04 in FIG. 8, the step B01 in FIG. 9).

The role mapping section 150 acquires an ID attribute I(u) every user u over all the users contained in the user ID set U (u∈U) from the ID attribute storage section 130 (the Step B02 on FIG. 9). When the ID attribute is represented in the form of {“attribute type”→(attribute set)}, the ID attribute of the user 1 is I(user 1)={“organization”→(research department, research division), “position”→(staff)}. The ID attribute of the user 2 is I(user 2)={“organization”→(research department, research division), “position”→(staff)}. The ID attribute of the user 3 is I(user 3)={“organization”→(research department, research division, and intellectual property division), “position”→(staff)}.

The role mapping section 150 takes out Ic={“organization”→(research department, research division), “position”→(staff)} from the ID attribute every user ID by setting the ID attribute common to all users as a common ID attribute Ic (the step B03 in FIG. 9).

The role mapping section 150 searches a role definition name having a role definition attribute which perfectly matches to the common ID attribute Ic={“organization”→(research department, research division), “position”→(staff)} from the role definition storage section 140. Here, the role mapping section 150 acquires the role definition name R(Ic)=“research staff” (the step B04 in FIG. 9).

The role mapping section 150 maps the access rule category 1 and the role definition name R(Ic)=“research staff”, and outputs a combination of the access rule category 1 and the role definition name R(Ic)=“research staff” to the role data storage section 160 (Step A05). The role data storage section 160 stores the combination of the access rule category 1, and the role definition name R(Ic)=“research staff”.

The role mapping section 150 repeats the step A03 to the step A05 until the role definition name is mapped to each of the access rule categories. Thus, the mapping is carried out to the access rule category 2 and the access rule category 3 in the same way.

Thus, the role definition name of “intellectual property staff” is mapped to the access rule category 2, the role definition name of “sales staff” is mapped to the access rule category 3, and the role definition name of “sales manager” is mapped to the access rule category 4, and they are stored in the role data storage section 160. Finally, when ending the mapping processing to all the access rule categories, the contents of the role data storage section are as shown in FIG. 6.

In this example, by automatically generating the access rule categories from the ACLs, and mapping them to the role definition names determined based on the organization and the position, a name which is easy for the access rule category to understand can be assigned. Also, it is possible to simply understand that the automatically generated access rule category relates to the user of which position of which organization. Therefore, the role which the security manager can easily recognize can be set without paying a high cost and departing from the actual condition of the scene.

In the above, the present invention has been described by referring to the exemplary embodiments (and examples). However, the present invention is not limited to the above exemplary embodiments (and examples). Various modifications that can be made by a person skilled in the art are contained in the scope of the present invention.

This patent application claims a priority based on Japan Patent Application No. JP 2009-209846 filed on Sep. 10, 2009. The disclosure thereof is incorporated therein by reference.

1. A role setting apparatus comprising:
an ACL classifying section configured to output an access rule category in which at least one permission and user IDs used to identify users as access subjects are related to each other, wherein said at least one permission is a combination of a resource ID used to identify a resource as an access object and an action defining permission or non-permission of an operation to said resource;
an ID attribute storage section configured to store said user IDs and attribute elements, which are related to each other;
an role definition storage section configured to store said attribute elements and role definition names, which are related to each other; and
a role mapping section configured to acquire a common attribute which is common to said user IDs, from said attribute elements stored in said ID attribute storage section based on said user IDs of said access rule category, acquire a first role definition name from said role definition names stored in said role definition storage section based on said common attribute, and relate said access rule category and said first role definition name.

2. The role setting apparatus according to claim 1, further comprising:
an ACL storage section configured to store a access rules, each of which is a combination of said permission and of user IDs,
wherein said ACL classifying section acquires a plurality of said access rules, sets said user IDs which are related to said permission contained in said plurality of access rules as a user ID set, and sets a combination of said user ID set and said permission as said access rule category.

3. The role setting apparatus according to claim 2, wherein said ACL storage section acquires said access rules from each of a plurality of servers.

4. A role setting method comprising:
outputting an access rule category in which at least one permission and a user IDs used to identify users as access subjects are related to each other, wherein said at least one permission is a combination of a resource ID used to identify a resource as an access object and an action defining permission or non-permission of an operation to said resource;
acquiring a common attribute which is common to said user IDs from an ID attribute storage section which relates and stores said user IDs and attribute elements, based on said user IDs of said access rule category;
acquiring a first role definition name from a role definition storage section which relates and stores said attribute elements and role definition names, based on said common attribute; and
relating said access rule category and said first role definition name.

5. The role setting method according to claim 4, wherein said outputting an access rule category comprises:
acquiring a plurality of access rules from said ACL storage section which stores said plurality of access rules, each of which is a combination of said permission and said user IDs;
setting said user IDs which are related to said permissions contained in said plurality of access rules, as a user ID set; and
outputting a combination of said user ID set and said permissions as said access rule category.

6. A non-transitory computer-readable storage medium in which a computer-executable role setting program code is stored to attain a role setting method which comprises:
outputting an access rule category in which at least one permission and user IDs used to identify users as access subjects are related to each other, wherein said at least one permission is a combination of a resource ID used to identify a resource as an access object and an action defining permission or non-permission of an operation to said resource;
acquiring a common attribute which is common to said user IDs from an ID attribute storage section which relates and stores said user IDs and attribute elements, based on said user IDs of said access rule category;
acquiring a first role definition name from a role definition storage section which relates and stores said attribute elements and role definition names, based on said common attribute; and
relating said access rule category and said first role definition name.

7. The non-transitory computer-readable storage medium according to claim 6, wherein said outputting an access rule category comprises:
acquiring a plurality of access rules from said ACL storage section which stores said plurality of access rules, each of which is a combination of said permission and said user IDs;
setting said user IDs which are related to said permissions contained in said plurality of access rules, as a user ID set; and
outputting a combination of said user ID set and said permissions as said access rule category.
